(19) United States
(12) Patent Application Publication
(10) Pub. No.: US 2007/0085660 A1
(43) Pub. Date: Apr. 19, 2007

(54) SERVICE PROVIDING METHOD, SERVICE PROVIDING APPARATUS AND COMPUTER READABLE INFORMATION RECORDING MEDIUM

(75) Inventor: Tooru Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/277,581

(22) Filed: Mar. 27, 2006

(30) Foreign Application Priority Data
Oct. 19, 2005 (JP) 2005-304860

(51) Int. Cl. G05B 19/00

(52) U.S. Cl. 340/5.81; 340/539.13; 340/539.11; 340/5.8; 340/10.3

(57) ABSTRACT

A service providing method includes the steps of: a) providing a correspondence between a tag and personal information; and b) providing a service to a person concerning the personal information, for which the correspondence with the tag is provided in the step a), wherein: the step a) comprises the step of registering identification information of an information processing apparatus which the person possesses as the personal information together with identification information of the tag.

### BACKGROUND OF THE INVENTION

1. Field of the Invention

The present invention relates to a service providing method, a service providing apparatus and a computer readable information recording medium.

2. Description of the Related Art

Recently, a system has been developed in such a manner that, as a result of a radio tag (RFID or such) being utilized as an identification device, a predetermined service is provided to a specific person. Spreading of an applicable field of a service employing such a radio tag is demanded especially in such a manner of applying IT technology, automating technology and so forth.

Japanese Laid-open Patent Applications Nos. 2004-126810, 2000-222551, 2002-083278 and 2001-005931 disclose related arts.

### SUMMARY OF THE INVENTION

In such a service providing system, a radio tag and personal information is provided with a correspondence therebetween. For this purpose, for example, a manager who issues a radio tag previously registers a correspondence between an ID and corresponding personal information in a database of a host computer, and then, the manager issues the radio tag to the corresponding person. Therefore, such a system that a radio tag is provided to a specific person with simultaneous registration of corresponding personal information may be difficult to achieve. As a result, a system of applying a radio tag as an entrance ticket for a theme park, a ticket for a transportation facility or such, and providing a specific service to a person corresponding to the tag, may be difficult to be put it into a practical application.

The present invention has been devised in consideration of such a problem, and an object of the present invention is to provide a method of building, effectively and easily, a system for providing a specific service to a person corresponding to a tag such as a radio tag.

According to the present invention, there are provided with the steps of a) providing a correspondence between a tag and personal information; and b) providing a service to a person concerning the personal information, for which the correspondence with the tag is provided in the step a), and, the step a) includes the step of registering identification information of an information processing apparatus which the person possesses as the personal information together with identification information of the tag.

Since the identification of the information processing apparatus which the person possesses is thus registered together with the identification information of the tag, the correspondence between the tag and the person can be easily obtained just in a site in which a service is actually provided.

Thus, according to the present invention, a correspondence between a particular user and a tag can be easily provided, for a case where the tag is handed to the user who uses any of various facilities such as a theme park, a transportation facility and so forth, and a specific service is provided to the user according to identification obtained with the use of the tag. Thus, a system of providing a service in an effective manner can be achieved even with a simple system configuration.

### BRIEF DESCRIPTION OF THE DRAWINGS

Other objects and further features of the present invention will become more apparent from the following detailed description when read in conjunction with the accompanying drawings:

FIG. 1 shows a block diagram illustrating an entire configuration of a service providing system according to an embodiment of the present invention;

FIG. 2 shows a flow chart illustrating an operation flow of a service providing method according to an embodiment of the present invention;

FIG. 3 illustrates a specific application example of a service providing system in one embodiment of the present invention;

FIG. 4 shows a block diagram of a computer as one example of a service providing apparatus according to one embodiment of the present invention; and

FIG. 5 shows one example of registered contents in a database of a service providing apparatus according to the embodiment of the present invention.

### DETAILED DESCRIPTION OF THE PREFERRED EMBODIMENTS

According to one mode of carrying out the present invention, predetermined information can be registered in a host computer with the use of a common apparatus for a case of registering corresponding personal information on the spot where a radio tag is provided to a specific user in a form of a ticket such as an entrance ticket for a theme park, a ticket for a transportation facility, or such.

That is, on surface of the radio tag in a form of the entrance ticket, transportation ticket or such being thus handed to a particular user, a so-called two-dimensional barcode (i.e., a QR code) is printed. The two-dimensional barcode has, in addition to an identification code (refereed to as an ‘ID code’, hereinafter) of the radio tag itself originally stored therein as electronic data, a URL of a Web site of to a server as the host computer having a database, and other attendant information (a date and a time at which the ticket is purchased, the fee paid for the ticket at this time, and so forth) in a form of a code obtained as a result of being encoded or enciphered.

The particular user operates a predetermined reading apparatus such as a cellular phone with a built-in camera for example to read in this two-dimensional barcode from the radio tag, which reading apparatus is connected with the server via a communication network according to the above-mentioned URL. The thus-read information, i.e., the above-mentioned ID code of the radio tag itself, as well as the above-mentioned attendant information, is transmitted to the server via the cellular phone in this example.

The server, thus receiving this information, registers personal information of this particular user with a correspondence to the above-mentioned ID code of the radio tag. At this time, a phone number of the cellular phone is also registered as the personal information of this user since the phone number of the cellular phone is transmitted to the server when the read information is transmitted via the cellular phone as mentioned above.

Thus, the specific user is registered with the correspondence to the identification information of the radio tag handed as the ticket to this user. As a result, this user can have services provided thereto with the use of the radio tag from this spot.

That is, as a result of the personal information of the specific user thus being registered in the server with the correspondence to the ID code of the radio tag, the following effects can be obtained: That is, when the user, carrying the radio tag, reaches a specific place in a theme park, a transportation facility or such, the existence the radio tag is detected by a predetermined sensor device provided in this place via a radio communication function. As a result, the ID code of the radio tag is detected simultaneously thanks to the well-known function of such a radio tag or an RFID. The ID code thus detected agrees with one registered in the server with the correspondence to the personal information of this user as mentioned above. Accordingly, through this correspondence, the fact that this specific user has reached the specific place is recognized accordingly. As a result, a predetermined service, corresponding to or unique to the recognition that this user has reached the specific place may be provided accordingly.

In order to make possible to provide the correspondence between the personal information of the specific user and the radio tag, the radio tag in the form of the ticket has the ID code has of the radio tag itself printed on this card-shaped radio tag itself in a form of the two-dimensional barcode as mentioned above. Accordingly, this ID code can be read out via the predetermined reading apparatus such as the cellular phone with the camera built therein as mentioned above.

The mode of carrying out the present invention has been thus described above, for example, in a form employing the card-shaped radio tag having the function of the ticket. However, a possible embodiment of the present invention is not limited thereto. That is, anything may be applied instead of the radio tag as long as it has a function of a ticket, an ID code thereof can be attached thereto in such a manner that the ID code may be read out by means of a predetermined reading apparatus, and also, the ID code can be detected at a place at which a service is provided. For example, not only in a form of an RFID, but also wide varieties, i.e., various sorts of non-contacting-type cards (including IC cards), and so fourth, may be applied for the same purpose.

Further, what is applicable as the above-mentioned reading apparatus includes, not only the above-mentioned well-known cellular phone with the built-in camera, but also any other various types of portable information terminal apparatuses having corresponding functions may be applied.

According to the present mode of carrying out the present invention, a service may be provided to a user on the spot where a place for actually providing the service where the radio tag is handed to the user, with the use of a radio tag, without requiring advanced user's registration for the radio tag handed to the user. Thus, the service can be provided in an advantageous manner especially for a system providing to a user the above-mentioned radio tag in a form of a ticket for a theme park, a transportation facility or such, and, with the use of the ticket, providing various services to the user depending on respective places in the facility.

A specific embodiment of the above-described mode of carrying out the present invention will now be described with reference to figures.

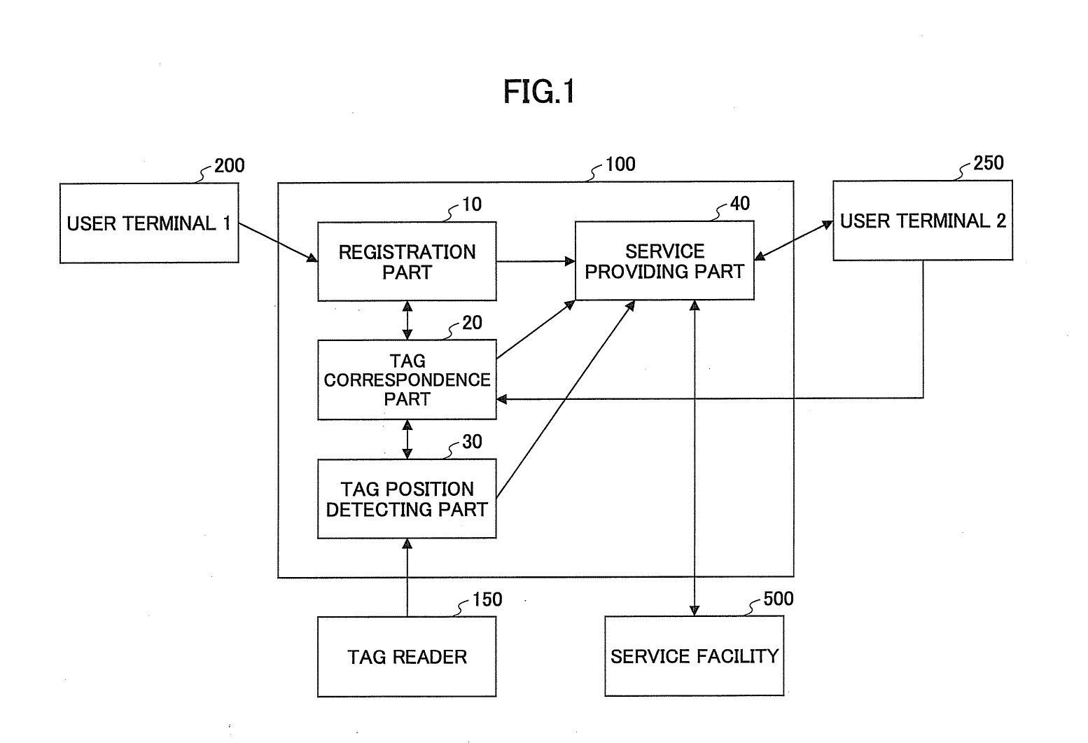

FIG. 1 shows a block diagram of the entire configuration of a service providing system according to one embodiment of the present invention.

As shown, the service providing system includes a service providing apparatus 100 having a registration part 10 receiving advanced registration from a user terminal 200, and further having a service providing part 40 actually providing a service according to the registration contents to a user concerning the registration.

The service providing apparatus 100 further includes, in addition to the registration part 10 and the service providing part 40, a tag correspondence part 20 providing a correspondence between a radio tag and a person concerning the registration; and a tag position detecting part 30 receiving a signal from a tag reader 150 which reads an ID code of the radio tag which the user carries when the user reaches a specific place in a predetermined facility for recognizing that the user reaches the place.

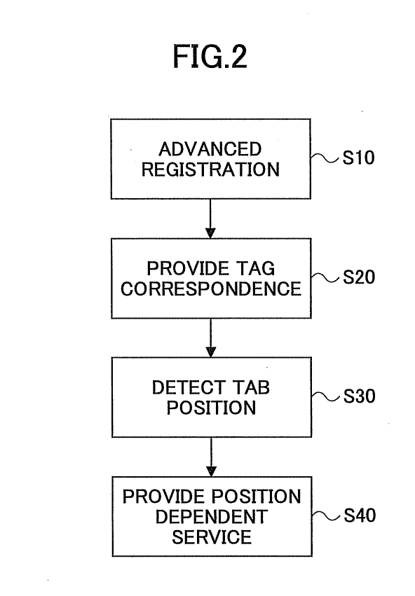

FIG. 2 shows a flow chart illustrating an operation flow in the service providing system shown in FIG. 1.

In Step S10, a user accesses the service providing apparatus 100 via a communication circuit such as the Internet, with the use of a terminal 200 (for example, a personal computer) of his or her own, and carries out advanced registration for receiving a service in future. At this time, the user registers not only the specific contents of the service to receive in future, but also personal information of his or her own (for example, a phone number and/or electronic mail address of his or her cellular phone, or such), together.

The registration part 10 in the service providing apparatus 100 which thus receives the registration information stores the information in a database.

In Step S20, when the user actually visits a service facility 500 by himself or herself after that, and receives a radio tag in a form of a ticket, the user operates his or her own terminal 250 (for example, a cellular phone) so as to read a two-dimensional barcode (QR code or such) previously printed on this ticket via a camera built in the cellular phone 250 in this example. This two-dimensional barcode stores an ID code of the radio tag itself, a URL of the above-mentioned service providing apparatus 100 shown in FIG. 1, and so forth.

Then, the user transmits, via the terminal 250 (i.e., the cellular phone), the ID code of the radio tag thus read as mentioned above in the form of the two-dimensional barcode via the same terminal 250 (i.e., the built-in camera of the cellular phone), to a Web site identified by the URL, also read as mentioned above in the form of the two-dimensional barcode. At this time, a phone number or an electronic mail address of the terminal 250 is also transmitted to the same Web site together automatically or manually. Since the Web site is of the service providing apparatus 100, the information thus transmitted to the Web site is received by the service providing apparatus 200 accordingly.

The tag correspondence part 20 of the service providing apparatus 100, receiving the information thus transmitted from the terminal 250, recognizes, from the personal information such as the phone number or the electronic mail address of the terminal 250 thus transmitted as mentioned above, that the user who has currently received the radio tag is identical to the user concerning the above-mentioned advanced registration made in Step S10, since the phone number or the electronic mail address of the terminal 250 should agree with the corresponding one registered in Step S10 by the same person (user). Then, the tag correspondence part 20 provides a correspondence between the ID code of the radio tag currently received as mentioned above together with the user's personal information, and also provides a correspondence to the advanced registration made in Step S10. Thus, corresponding registration is again carried out with the thus-provided correspondences.

Then, in Step S30, when the user reaches a specific place in the service facility 500 (for example, a theme park), the ticket-shaped radio tag which the user carries is detected by a tag reader 150 located at the specific place. At this time, the tag reader 150 reads the ID code which the radio tag has, via radio communication.

A configuration required for reading the ID code which the radio tag has, via radio communication, is well-known as an art of RFID technology (see Japanese Laid-open Patent Applications Nos. 2000-222551, 2002-083278 and 2001-005931, for example), and detailed description therefor is omitted.

As a result, the tag position detecting part 30 of the service providing apparatus 100 recognizes that the user has reached the specific place in the facility 500, from the ID code of the radio tag thus read by the tag reader 150 and the position at which the same tag reader 150 is located.

That is, the ID code thus read agrees with the same registered with the correspondence to the same user, since the same ID code has been already read by the terminal 250 of the same user in Step S20 as mentioned above. As a result, the fact that the radio tag which the user carries has reached the position of the tag reader 150 is recognized.

Then, in Step S40, the service providing part 40 reads the registered contents for the service registered in Step S10 by the registration part 10, i.e., the registered contents as to which service the user wishes to receive. Then, the service providing part 40 provides the service, which is determined according to the registered contents, and also is determined according to the above-mentioned specific place in the facility 500 recognized in Step S30, to the user.

Specifically, predetermined guidance information or such concerning the place is delivered to the phone number or the electronic mail address of the cellular phone (i.e., the terminal 250) of the user, which has been already registered in Step S10 by the registration part 10.

Thus, according to the embodiment of the present invention, the correspondence is provided between the ID code of the radio tag as the ticket for the service facility 500 and the specific user who receives and then carries the radio tag, not at the time of the advanced registration in Step S10 but when the user actually visits the corresponding facility 500 and thus receives the ticket (radio tag) in Step S20.

Accordingly, work of issuing the ticket upon the advanced registration, and mailing the same for the user, requiring the user to visit a ticket counter and receive the ticket upon the advanced registration, or such, can be omitted.

In the system of the present embodiment, what should be done by the user is merely to receive the ticket first just at the spot where he or she actually receives the service, and to transmit the ID code or such printed on the ticket to the service providing apparatus 100. Immediately after that, the user can receive the service. In this case, the phone number of the cellular phone or such, which is personal information previously registered for the correspondence to the ID code of the radio tag, is transmitted to the service providing apparatus 100 from the cellular phone at the same time when the ID code of the radio tag is transmitted to the service providing apparatus 100.

At this time, since the URL of the Web site of the service providing apparatus 100 is read from the ticket simultaneously, the user is free from manually inputting the URL of the same site for actually accessing the Web site.

Thus, according to the present embodiment of the present invention, convenience of the user can be effectively improved.

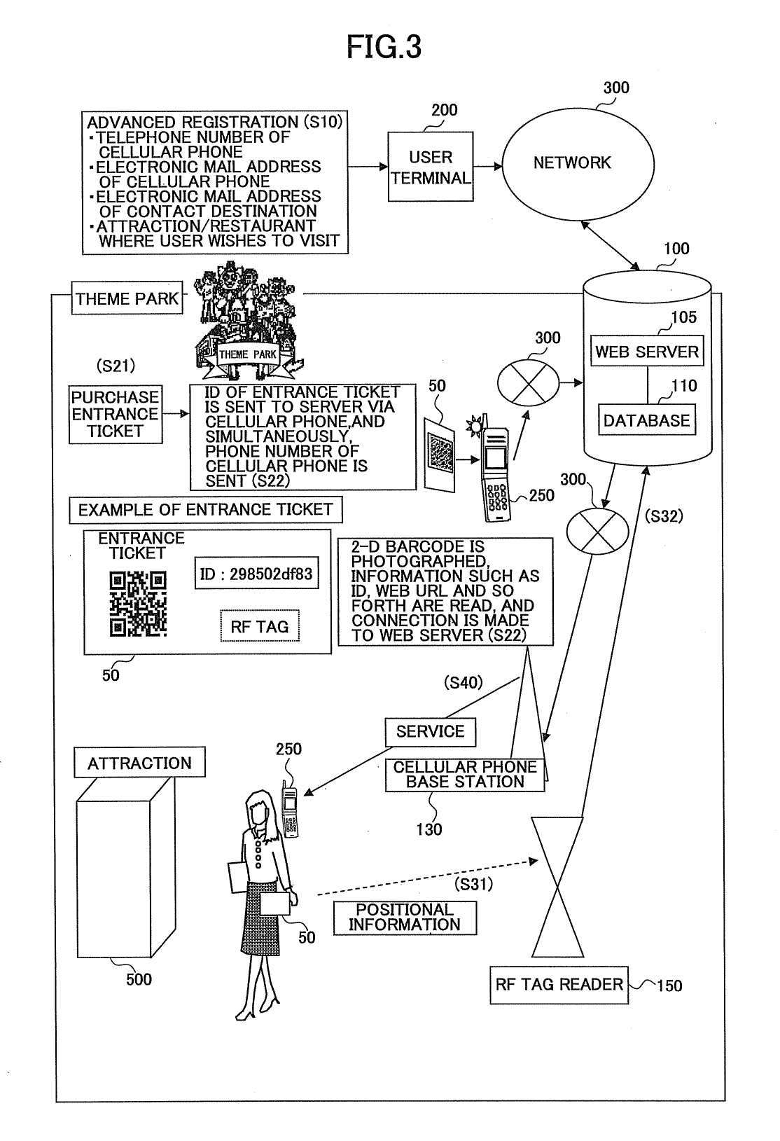

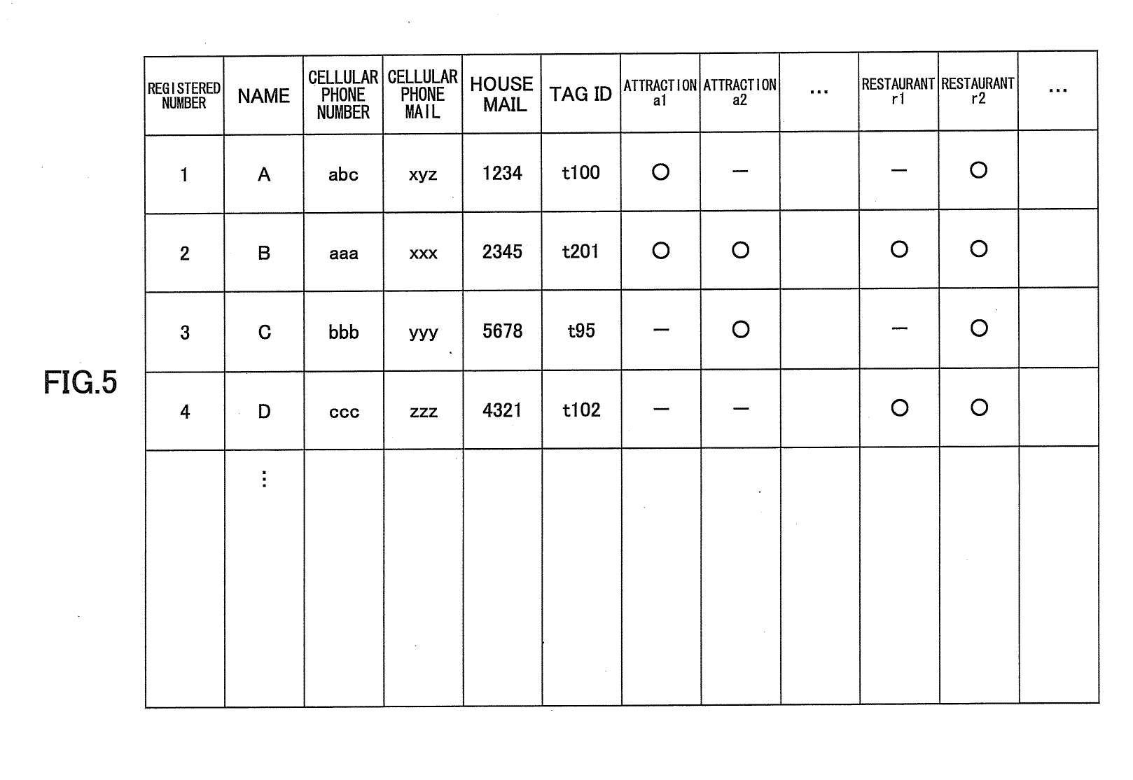

The present embodiment will now be further described for a case where a service is provided to a user who enters a theme park, for example, with reference to FIGS. 3 and 5.

First, in Step S10 of FIG. 3, the user makes advanced registration for attractions, restaurants, and so forth, where the user plans to visit in-the theme park. This advanced registration is made by the user as a result of the user accessing an URL of a Web site corresponding to the theme park with the use of the terminal apparatus 200 such as a home personal computer of his or her own and inputting predetermined information according to a guidance provided by the Web site.

As shown in FIG. 3, the service providing apparatus 100 has a Web server 105 and a database 110. The Web server 105 receives a transmission signal concerning the above-mentioned advanced registration made via the communication network 300 from the personal computer 200 as the above-mentioned user terminal, and stores the registration contents in the database 110.

FIG. 5 shows one example of specific contents thus registered in the database 110.

As shown in FIG. 5, in this case, the user's name, a phone number of his or her cellular phone, an electronic mail address of the same, an electronic mail address of his or her home personal computer, attractions, restaurants, and so forth where the user planes to visit, and so forth are registered. It is noted that an item of ‘tag ID’ of a number of items of registration contents shown in FIG. 5 is not yet registered in this stage of the advanced registration, and thus, nothing is set there.

For example, assuming the user is ‘A’ having the registration number 1 shown in FIG. 5, as shown, the name ‘A’ of this user, the phone number ‘abc’ of his or her cellular phone 250, the electronic mail address xyz of the same, the electronic mail address ‘1234’ of his or her home personal computer, an attraction ‘a1’ and a restaurant ‘r2’, as places where the user planes to visit, are registered.

Then, after that, the user actually visits the theme park and purchases an entrance ticket 50 in Step S21. This entrance ticket has a function of a radio tag in addition to the original function of the theme park entrance ticket, as mentioned above. This radio tag as the entrance ticket 50 has its ID code embedded therein as a unique ID (identification information). Also, on a surface of this entrance ticket 50, a two-dimensional barcode is printed. This two-dimensional barcode is one obtained from information including the above-mentioned ID code of this radio tag (entrance ticket 50) itself, the URL of the Web site for the Web server 105, and so forth, being coded.

In Step S22, the user operates the own cellular phone 250 so as to read this two-dimensional barcode from the entrance ticket 50 by means of a camera built in the cellular phone 250. Then, the URL of the Web site for the Web server 105 is connected-with the cellular phone 250 according to the URL thus included in the read information. Then, to the Web server 105, the ID code of the radio tag (entrance ticket 50), also included in the read information, is transmitted via the Web site. At this time, the phone number of the cellular phone 250, which is the transmission source, is transmitted to the Web server accordingly. It is assumed that the ID code of this radio tag (entrance ticket 50) is ‘t100’.

As the user's name is assumed as ‘A’ as mentioned above, the phone number of the cellular phone thus transmitted is ‘abc’, as shown in FIG. 5.

The Web server 105 searches the stored information of the database 110 for the registered information concerning the above-mentioned advanced registration shown in FIG. 5, with the use of the phone number ‘abc’ of the cellular phone which is included in the information thus transmitted from the cellular phone 250. As a result, a record of the person ‘A’ is obtained since this record has the identical phone number of ‘abc’, i.e., the record No. 1, together with the other registered contents belonging to this record.

As a result, the Web server 105 recognizes that the specific user corresponding to this record No. 1, i.e., the person ‘A’ has received the radio tag (50) having the ID code ‘t100’. Then, the Web server 105 newly registers this ID code ‘t100’ in the item of the tag ID belonging to this record No. 1 (see FIG. 5). Thus, a correspondence is provided between the ID code of the radio tag (entrance ticket 50) and the advanced registration record for the user who carries this radio tag and is to receive a corresponding service.

Technology of obtaining information of the two-dimensional barcode (QR code or such) with the camera built in the cellular phone, as mentioned above, is well-known, and thus, details thereof is omitted.

After that, the user (person ‘A’) enters the theme park. Then, when the person ‘A’ approaches the tag reader 150 set at each of predetermined spots (a plurality of places), the tag reader 150 detects the radio tag as the entrance ticket 50, which the person ‘A’ carries, by means of radio communication via an antenna of the tag reader 150, and thus reads the ID code of the radio tag (entrance ticket 50) in Step S31.

The thus-obtained information is transmitted to the service providing apparatus 100 from the tag reader 150 in Step S32, and the service providing apparatus 100 receiving the information searches the database 110 shown in FIG. 5 with the thus-obtained ID code as a search key.

In this case, since the ID code of the radio tag which the person ‘A’ carries is ‘t100’ as mentioned above, the registered contents of the record No. 1 having this code in the ‘tag ID item’ of the record are obtained.

Next, the service providing apparatus 100 compares the actual location of the tag reader 150, from which the above-mentioned ID code of the radio tag (entrance ticket 50) which the person ‘A’ carries has been thus transmitted, with the thus-obtained registered contents of the record No. 1 of the database 110, i.e., the attraction a1 and the restaurant r1 where the person ‘A’ previously registered for visiting as mentioned above (see FIG. 5).

Then, when the tag reader 150 having transmitted the above-mentioned ID code is located near any of these registered places, the service providing part 100 transmits guidance information for the corresponding place to the phone number ‘abc’ or the electronic mail number ‘xyz’ included in this record No. 1 in Step S40. The guidance information thus transmitted may include, for example, a waiting time, vacant sheet information or such for the corresponding place, i.e., the attraction a1 or the restaurant r2, which information is transmitted to the cellular phone 250 from the service providing apparatus 100 via the communication network 300 at appropriate timing.

Thus, according to the present embodiment of the present invention, a correspondence can be easily made between the contents of the advanced registration for the user who is to receive the service and the place the user actually reaches. As a result, the information concerning the place where the user currently visits can be appropriately provided to the user in a manner suitable to this place. Furthermore, according to the embodiment of the present invention, when the user approaches the certain place, information suitable to an actual distance to the place may be provided to the user, for example. Thus, the user's convenience can be effectively improved.

Information to be provided to the user in Step S40 is not limited to the above-mentioned ones, i.e., a waiting time, vacant sheet information or such. Other than these, for example, displaying a menu of the restaurant, providing guidance for actually taking an order for a meal, for taking a reservation for sheets, or so, may be provided.

Further, information to be provided to the user in Step S40 may include a photograph of the user himself or herself taken when the user rides a vehicle of the attraction of the theme park, for example. In such a case, by means of the function of the radio tag (entrance ticket 50) which the user carries, a specific vehicle which the user actually rides can be identified. As a result, photographs concerning the identified vehicle which the user actually rode can be extracted from among those concerning the corresponding attraction. As a result, guidance for an order for only a photograph concerning the specific user can be provided appropriately. As a result, the user can be free from searching photographs including those irreverent to the user himself or herself. Thus, the user can efficiently take an order for the relevant photograph.

Similarly, information to be provided to the user in Step S40 may include a record indicating an actual route along which the user moved in the theme park, photographs taken by security cameras set in the theme park, or such.

Such record information may be obtained by the user in his or her home as a result of he or she again connects to the Web site of the Web server 105, to which connection was already made in Step S10 upon the advanced-registration.

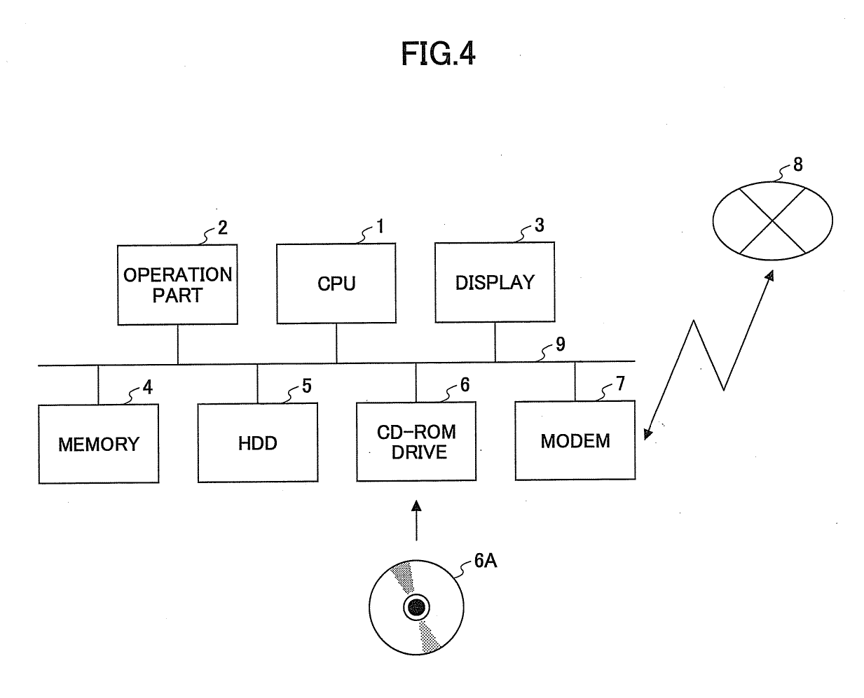

FIG. 4 shows a block diagram of a computer applicable as the above-mentioned service providing apparatus 100.

As shown, the computer of FIG. 4 includes a CPU 1 carrying out execution control of the computer itself, an operation part 2 for an operator to input various sorts of instructions, data or such, a display 3 for displaying to the operator various sorts of information (including user interface), a memory 4 usable as a work area upon control operation executed by the CPU 1, a hard disk drive 5 storable of various sorts of programs and so forth, a CD-ROM drive 6 for loading programs, data or such externally via a CD-ROM 6a as a carriable information recording medium and a modem 7 for downloading programs, data or such from an external server via a communication network 8 such as the Internet. These respective parts are connected via a bus 9 so that they communicate each other.

The above-mentioned operation part 2 includes a keyboard, a mouse, and so forth. The display 3 includes not only a display screen, but also a printer or such.

In order that the computer operates as the embodiment of the service providing apparatus according to the present invention, a program including instructions for causing the computer to act as the service providing apparatus 100 as the embodiment of the present invention described above with reference to FIGS. 1 through 3 and 5, is produced first. Then, the program is loaded in the computer via the CD-ROM 6a or via the communication network 8. Then, the program thus loaded in the computer is stored in the hard disk drive 5 and thus installed in the computer.

Then, after that, the instructions of the program are executed by the CPU 1 in sequence, and thus, the computer operates as the service providing apparatus according to the embodiment of the present invention.

Further, the present invention is not limited to the above-described embodiment, and variations and modifications may be made without departing from the basic concept of the present invention claimed below.

The present application is based on Japanese Priority Application No. 2005-304860, filed on Oct. 19, 2005, the entire contents of which are hereby incorporated herein by reference.

What is claimed is:

1. A service providing method comprising the steps of:
a) providing a correspondence between a tag and personal information; and
b) providing a service to a person concerning the personal information, for which said correspondence with the tag is provided in said step a), wherein:
said step a) comprises the step of registering identification information of an information processing apparatus which said person possesses as said personal information together with identification information of said tag.

2. The service providing method as claimed in claim 1, further comprising the step of:
c) detecting a position of said tag, wherein:
in said step b), a service dependent on the position detected in said step c) is provided.

3. The service providing method as claimed in claim 1, further comprising the step of:
c) registering service contents with a connection to the personal information, wherein;
in said step b), a service concerning the service contents registered with the connection to the personal information is provided to the person concerning said personal information.

4. The service providing method as claimed in claim 1, wherein:
said tag comprises a RFID storing predetermined information and
in said step b), positional information of said tag is obtained as a position of a predetermined reading apparatus as a result of the stored predetermined information being read from the tag by said predetermined reading apparatus, and a service dependent on said positional information is provided to the person.

5. The service providing method as claimed in claim 1, wherein:
said identification information as the personal information comprises contact information for said information processing apparatus, and
in said step b), predetermined information is delivered to the contact destination.

6. The service providing method as claimed in claim 1, wherein:
said step b) comprises the step of providing guidance information for the use of a predetermined facility, and providing different guidance information dependent on each place of a plurality of predetermined places of said facility, said place being identified by a function of said tag.

7. A service providing apparatus comprising:
a correspondence providing part of providing a correspondence between a tag and personal information; and
a service providing part of providing a service to a person concerning the personal information, for which said correspondence with the tag is provided by said correspondence providing part, wherein:
said correspondence providing part registers identification information of an information processing apparatus which said person possesses as said personal information together with identification information of said tag.

8. The service providing apparatus as claimed in claim 7, further comprising:
a detecting part of detecting a position of said tag, wherein:
said service providing part provides a service dependent on the position detected by said detecting part.

9. The service providing apparatus as claimed in claim 7, further comprising:
a registering part of registering service contents with a connection to the personal information, wherein;
said service providing part provides a service concerning the service contents registered with the connection to the personal information to the person concerning said personal information.

10. The service providing apparatus as claimed in claim 7, wherein:
said tag comprises a RFID storing predetermined information; and
said service providing part obtains positional information of said tag as a position of a predetermined reading apparatus as a result of reading the stored predetermined information from said tag by said predetermined reading apparatus, and providing a service dependent on said positional information to said person.

11. The service providing apparatus as claimed in claim 7, wherein:
said identification information as the personal information comprises contact information for said information processing apparatus, and
said service providing part delivers predetermined information to the contact destination.

12. The service providing apparatus as claimed in claim 7, wherein:
said service providing part provides guidance information for the use of a predetermined facility, and provides different guidance information dependent on each place of a plurality of predetermined places of said facility, said place being identified by a function of said tag.

13. A computer readable information recording medium storing a program comprising instructions for causing a computer to operate as:
a correspondence providing part of providing a correspondence between a tag and personal information; and
a service providing part of providing a service to a person concerning the personal information, for which said correspondence with the tag is provided by said correspondence providing part, wherein:
said instructions causing the computer to operate as said correspondence providing part comprises instructions for causing the computer to operate to register identification information of an information processing apparatus which said person possesses as said personal information together with identification information of said tag.

14. The computer readable information recording medium as claimed in claim 13, said program further comprising instructions to cause the computer to operate as:
a detecting part of detecting a position of said tag, wherein:
the instructions to cause the computer to operate as said service providing part comprise instructions to cause the computer to provide a service dependent on the position detected by said detecting part.

15. The computer readable information recording medium as claimed in claim 13, said program further comprising instructions to cause the computer to operate as:
a registering part of registering service contents with a connection to the personal information, wherein;
the instructions to cause the computer to operate as said service providing part comprise instructions to cause the computer to provide a service concerning the service contents registered with the connection to the personal information to the person concerning said personal information.

16. The computer readable information recording medium as claimed in claim 13, wherein:
said tag comprises a RFID storing predetermined information; and
the instructions to cause the computer to operate as said service providing part comprise instructions to cause the computer to obtain positional information of said tag as a position of a predetermined reading apparatus as a result of reading the stored predetermined information from said tag by said predetermined reading apparatus, and providing a service dependent on said positional information to said person.

17. The computer readable information recording medium as claimed in claim 13, wherein:
said identification information as the personal information comprises contact information for said information processing apparatus, and
the instructions to cause the computer to operate as said service providing part comprise instructions to cause the computer to deliver predetermined information to the contact destination.

18. The computer readable information recording medium as claimed in claim 13, wherein:
the instructions to cause the computer to operate as said service providing part comprise instructions to cause the computer to provide guidance information for the use of a predetermined facility, and provide different guidance information dependent on each place of a plurality of predetermined places of said facility, said place being identified by a function of said tag.
